(19) United States
(12) Patent Application Publication
(10) Pub. No.: US 2025/0138554 A1
(43) Pub. Date: May 1, 2025

(54) NAVIGATION SYSTEM AND METHOD INCLUDING AN AUTONOMOUS INTELLIGENT MOTORIZED AUDIBLE NAVIGATION CART

(71) Applicant: Angelina Gauthney, Camden, NJ (US)

(72) Inventor: Angelina Gauthney, Camden, NJ (US)

(21) Appl. No.: 18/928,745

(22) Filed: Oct. 28, 2024

Related U.S. Application Data
(60) Provisional application No. 63/593,309, filed on Oct. 26, 2023.

(51) Int. Cl. G05D 1/656; A61G 5/04; B25J 5/00; B25J 13/02; B62B 5/00; G05D 1/247; G05D 1/689; G05D 107/60; G05D 111/30

(52) U.S. Cl. CPC G05D 1/656; B25J 5/007; B25J 13/025; B62B 5/0033; B62B 5/0069; G05D 1/247; G05D 1/6895; A61G 5/041; B62B 5/002; G05D 2107/67; G05D 2111/32; G05D 2111/34

(57) ABSTRACT

A navigation system and method including an autonomous intelligent motorized audible navigation cart. The audible and intelligent features of the navigation system can be accomplished using a combination of artificial intelligence and speech recognition technology. The navigation system can be used to help the visually impaired person navigate a store for locating products.

### BACKGROUND OF THE INVENTION

### Field of the Invention

The present invention relates generally to the field of electronically aided navigation and in particular to a navigation system including an autonomous intelligent motorized audible navigation cart and application interface to allow users to interactively navigate or tour a location, such as a store or airport, to locate and removably store items within the cart.

### Description of Related Art

Systems for the visually impaired to navigate a route through a facility are known. U.S. Pat. No. 6,839,629 describes a system and method of the type for aiding a user in navigating a route through a facility so as too efficiently locate specific items within a facility. The system includes a facility processor having a database and software stored thereon for mapping an interactive route from a selected location to a selected location within a facility, a label located proximate individual items, the label electronically communicating information specific to the item it is associated with, and a digital device having the interactive route electronically stored thereon. The digital device electronically communicating with the facility processor and the labels for tracking movement of the digital device along the route via communication with the labels and communicating a direction to move to follow the route.

It is desirable to provide an improved system including an autonomous intelligent motorized audible navigation cart and application interface to allow users to interactively navigate a facility such as a store to locate and put items into the autonomous intelligent motorized audible navigation cart during navigation through the store.

### BRIEF SUMMARY OF THE INVENTION

The present invention relates a navigation system and method including an autonomous intelligent motorized audible navigation cart. The audible and intelligent features of the navigation system can be accomplished using a combination of Artificial Intelligence and speech recognition technology. The Artificial Intelligence system can be trained on a dataset of product names and descriptions which are in a particular location. For example, the dataset could be obtained from a website of a store, such as a supermarket. A facial recognition system can allow the autonomous intelligent motorized audible navigation cart to identify customers and personalize their shopping experience. The Artificial Intelligence system can customize the navigation system to the products of interest to a particular customer. Speech recognition technology at a user interface, such as an app, translates audible data into to text. By downloading at the user interface an app, from for example an Apple Store or Google Play Store, and pairing it with the autonomous intelligent motorized audible navigation cart, users can access the supermarket's website and begin their shopping experience. The Artificial Intelligence system can use map data to calculate the shortest path to one or more destinations and between destinations within the store. The Artificial Intelligence system can send navigation instructions to a motor controller of the autonomous intelligent motorized audible navigation cart. The motor controller can move the cart along path calculated by the Artificial Intelligence system.

In one embodiment, a customer speaks into the app and requests a product. The speech recognition technology transcribes the customer's audible request into text. The voice-activated control system allows customers to control the cart without having to use their handheld cell phone.

The Artificial Intelligence system can use data from a database of products to identify a product associated with the request. The Artificial Intelligence system can generate audible instructions to the customer for navigation of a path to the product and/or the motor controller can automatically transport the customer to the product. A robotic arm of the autonomous intelligent motorized audible navigation cart can be used to pick up located products or items at the destination and removably store them in the autonomous intelligent motorized audible navigation car.

Cellular network technology, such as for example fifth generation (5G) or tenth generation (10G) can be used by the navigation system of the present invention for navigation services of the autonomous intelligent motorized audible navigation cart. The navigation system of the present invention can include a tracking system to track the position of the autonomous intelligent motorized audible navigation cart in real time. A safety feature can prevent the motor controller from moving the autonomous intelligent motorized audible navigation cart if an obstacle is detected in the way of the autonomous intelligent motorized audible navigation cart.

To ensure privacy, IP addresses are protected, and the navigation system is equipped with data and cloud computing of cybersecurity and infrastructure awareness systems that can include activity, alerts, bulletins, and analysis reports. Additionally, a vertical private network (VPN) can be downloaded by the user to increase privacy protection, such as Mozilla's VPN, which provides full online anonymity, hides the user's IP address, and offers safe peer to peer (P2P) torrenting and public Wi-Fi security on all devices. The device can utilize heatmaps, like AUVIK heatmap, to create clear and simple network topology diagrams with easy-to-use cloud-based networking management. Cybersecurity and heatmaps c to develop can be used to monitor software network topology and diagrams to include real-time network mapping with optimized audible and processing speeds.

In one embodiment, the navigation system can be used to help the visually impaired person navigate a store for locating products. In one embodiment, the navigation system can be used by a visually impaired person employed as a restocking person or a customer service representative. The navigation system can also be used to help the restocking person navigate to a location for a product to be shelved or located. The navigation system can be used by a visually impaired person to communicate with customers.

The navigation system of the present invention has the advantages of allowing: visually impaired people to be employed in a wider range of jobs; making it easier for visually impaired people to communicate with customers; and improving the efficiency of the restocking process for visually impaired people.

The navigation system of the present invention has the advantage of allowing people with language barriers to shop and communicate with store employees. The navigation system can include a translation feature to allow customers to communicate with store employees in their native language making it easier for people with language barriers to shop and communicate with store employees.

The navigation system of the present invention can be used to help people with cognitive disabilities shop and stay organized. The navigation system can provide prompts and reminders to the user. The navigation system can be used to track the customer's progress through the store making it easier for people with cognitive disabilities to shop independently and stay organized.

The navigation system of the present invention can be used to transport luggage through airports, bus stations, subway stations and train stations. The robotic arm of the autonomous intelligent motorized audible navigation cart can be used to pick up and place luggage on the cart making it easier for people with physical disabilities to transport their luggage.

The Artificial Intelligence system can provide a personalization feature which uses a database of customer purchase histories to remember what products a customer has purchased in the past. The personalization feature uses the information from the purchase histories to suggest items that the customer might be interested in purchasing. The personalization feature can use information directed to a customer's dietary restrictions or allergies upon request. The personalization feature can use a database of recipes to provide meal planning or recipe suggestions based on the items removably stored in the autonomous intelligent motorized audible navigation cart.

The navigation system can include a tracking system to keep track of a fleet of autonomous intelligent motorized audible navigation carts in one location. The tracking system can include a combination of WI-FI and RFID technology. The autonomous intelligent motorized audible navigation carts can have trackers to track the autonomous intelligent motorized audible navigation carts in real-time. The autonomous intelligent motorized audible navigation carts can have RFID tags to allow the autonomous intelligent motorized audible navigation carts to be identified by a fleet management system.

The fleet management system can provide information to keep track of the location and availability of each autonomous intelligent motorized audible navigation carts. The user interface including an app can be used to reserve the autonomous intelligent motorized audible navigation cart in advance. The reservation system of the app can allow customers to reserve a cart for a specific time window. The reservation system of the app ensures that customers short wait times or no wait time for using one of the autonomous intelligent motorized audible navigation carts. The fleet management system can be used to track usage patterns of the autonomous intelligent motorized audible navigation carts. This track usage patterns be used to identify which autonomous intelligent motorized audible navigation carts are in the most demand and to adjust the fleet of the autonomous intelligent motorized audible navigation carts accordingly.

Once shopping is completed, the autonomous intelligent motorized audible navigation carts can navigate the customer to the least crowded checkout line. Alternatively, the autonomous intelligent motorized audible navigation carts can be equipped with technology for scanning and payment processing for completing a payment transaction of items with the cart. After payment, autonomous intelligent motorized audible navigation cart can navigate the customer to the exit, or a designated area while waiting for the customer to unload the purchased items. After the customer leaves, the autonomous intelligent motorized audible navigation cart automatically resets for the next customer, sanitizing itself with such functionality, and returns to its initial position to await the next user.

The autonomous intelligent motorized audible navigation cart is particularly useful for people with disabilities such as visual, hearing and lower and/or upper-body mobility. The navigation system including the autonomous intelligent motorized audible navigation cart can be used to transport groceries, luggage, or other heavy items for the user to make it easier for people with disabilities to shop and travel.

In one embodiment, the autonomous intelligent motorized audible navigation cart can include force feedback and a haptic feedback system. The autonomous intelligent motorized audible navigation cart provides an enhanced sensory experience as a multi-sensory experience for deaf-blind users, allowing them to perceive and interact with their environment in new ways. The autonomous intelligent motorized audible navigation cart uses intuitive control to leverages the user's natural sense of touch to create an intuitive and accessible control mechanism for the robotic arm. The autonomous intelligent motorized audible navigation cart provides increased independence of the user to allow deaf and/or blind users to explore and manipulate objects independently, fostering greater autonomy and confidence. The autonomous intelligent motorized audible navigation cart establishes a clear and effective communication channel between the user and the robotic arm, enhancing understanding and control. The autonomous intelligent motorized audible navigation cart allows deaf-blind individuals to engage with the world, access information, and perform tasks that were previously challenging or inaccessible.

The invention will be more fully described by reference to the following drawings.

### BRIEF DESCRIPTION OF THE DRAWING(S)

FIG. 1A. is a schematic diagram a navigation system in accordance with the teachings of the present invention;

FIG. 1B. is a schematic diagram a navigation system including haptic feedback in accordance with the teachings of the present invention;

FIG. 1C is a schematic diagram of a user interface used in the navigation system.

FIG. 2A is a front and side perspective view of the autonomous intelligent motorized audible navigation cart used in the navigation system;

FIG. 2B is a rear and side perspective view of the autonomous intelligent motorized audible navigation cart used in the navigation system;

FIG. 2C is a side view of the autonomous intelligent motorized audible navigation cart used in the navigation system;

FIG. 2D is a top view of the autonomous intelligent motorized audible navigation cart used in the navigation system;

FIG. 2E is a front view of the autonomous intelligent motorized audible navigation cart used in the navigation system;

FIG. 2F is a rear view of the autonomous intelligent motorized audible navigation cart used in the navigation system;

FIG. 3A is a front and side perspective view of a user transport chair used in the navigation system;

FIG. 3B is a rear and side perspective view of the user transport chair;

FIG. 3C is a side view of the user transport chair;

FIG. 3D is a top view of the user transport chair;

FIG. 3E is a front view of the user transport chair;

FIG. 3F is a rear view of the user transport chair;

FIG. 4A is a front and side perspective view of a platform housing used in the cart transport apparatus;

FIG. 4B is a rear and side perspective view of the platform housing;

FIG. 4C is a side view of a platform housing;

FIG. 4D is a top view of a platform housing;

FIG. 4E is a front view of a platform housing;

FIG. 4F is a rear view of a platform housing;

FIG. 4G is a rear view of a platform housing;

FIG. 5A is a front and side perspective view of a cart used in the navigation system;

FIG. 5B is a rear and side perspective view of the cart;

FIG. 5C is a side view of the cart;

FIG. 5D is a top view of the cart;

FIG. 5E is a front view of the cart;

FIG. 5F is a rear view of the cart;

FIG. 6A is a front and side perspective view of the autonomous intelligent motorized audible navigation cart including a sanitization station;

FIG. 6B is a rear and side perspective view of the autonomous intelligent motorized audible navigation cart including a sanitization station;

FIG. 6C is a side view of the autonomous intelligent motorized audible navigation cart including a sanitization station;

FIG. 6D is a top view of the autonomous intelligent motorized audible navigation including a sanitization station;

FIG. 6E is a front view of the autonomous intelligent motorized audible navigation cart including a sanitization station;

FIG. 6F is a rear view of the autonomous intelligent motorized audible navigation cart including a sanitization station;

FIG. 7 is a flow diagram of a method for navigation of the autonomous intelligent motorized audible navigation cart;

FIG. 8 is a flow diagram of a method for audible navigation of the autonomous intelligent motorized audible navigation cart; and

FIG. 9 is a schematic diagram of an embodiment of a navigation system in accordance with the teachings of the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

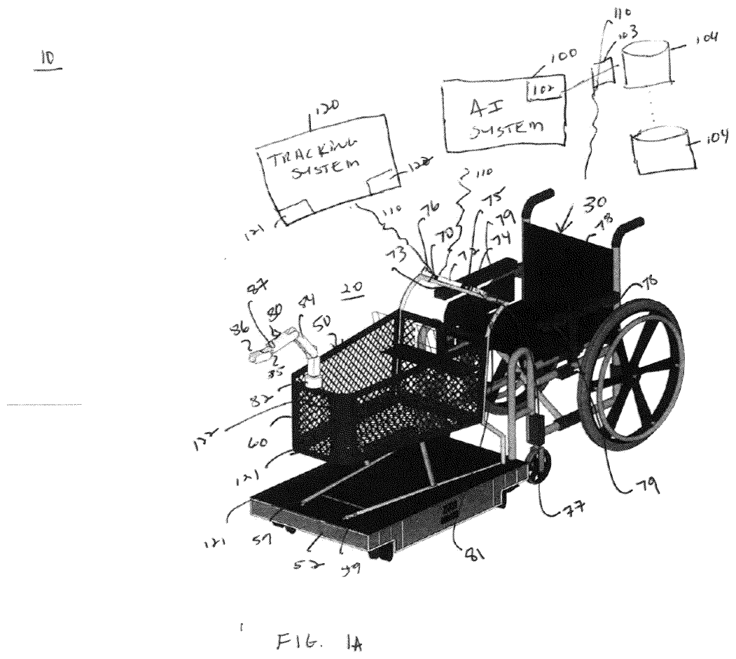

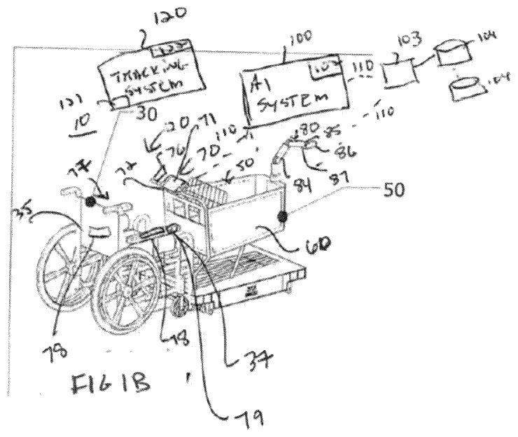

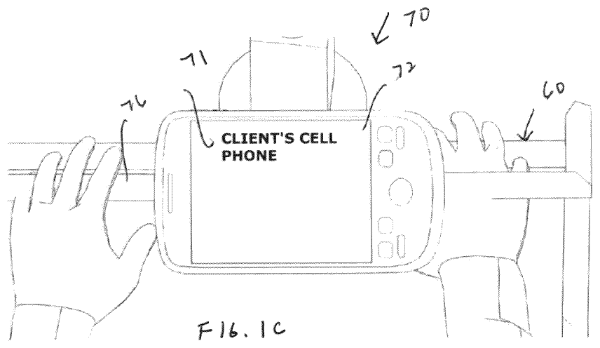

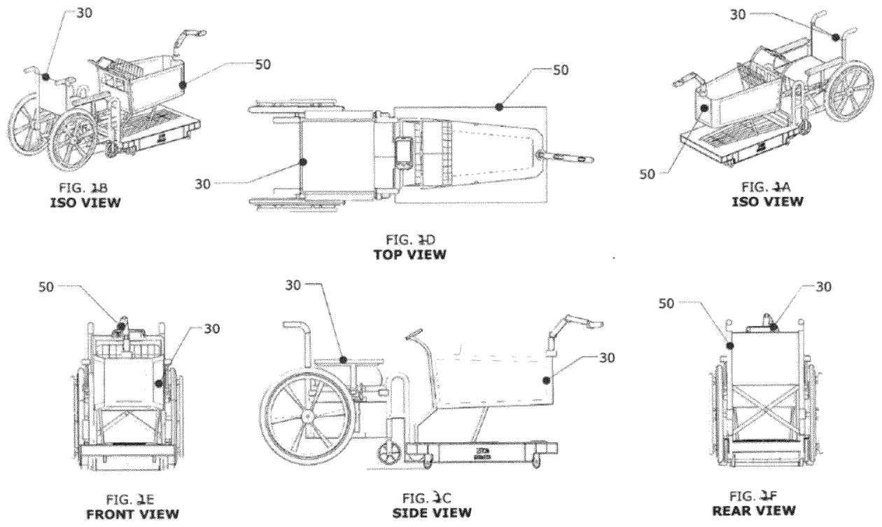

FIGS. 1A-1C are schematic diagrams of navigation system 10 in accordance with the teaching of the present invention. Navigation system 10 includes autonomous intelligent motorized audible navigation cart 20. Referring to FIGS. 2A-2F, autonomous intelligent motorized audible navigation cart 20 includes user transport chair 30. User transport chair 30 is removably coupled to shopping cart transport apparatus 50.

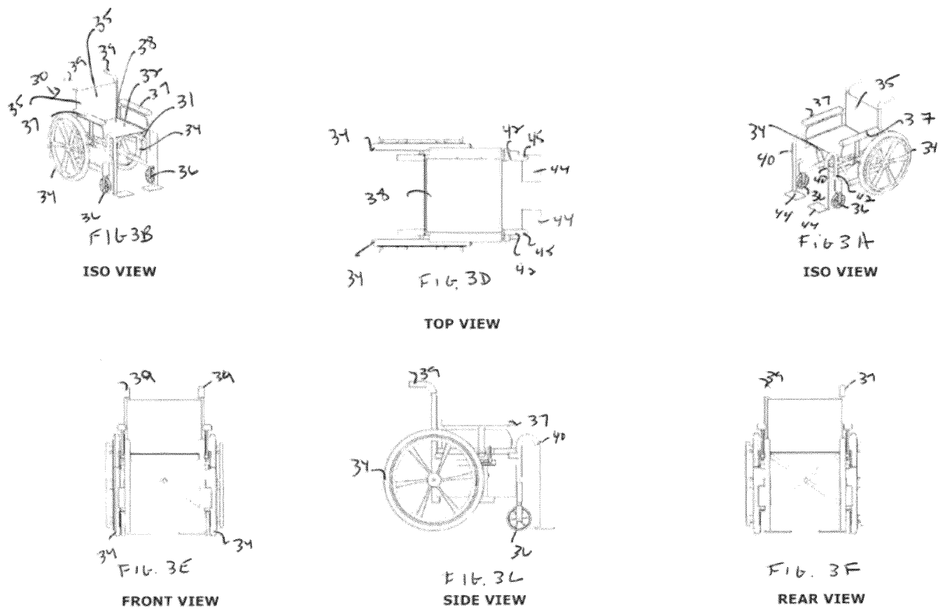

Referring to FIGS. 3A-3F, user transport chair 30 includes frame 31 attaching chair 32 to rear wheels 34 and front wheels 36. Chair 32 can include backrest 35. Chair 32 can include armrests 37 on opposite sides of seat 38. Frame 31 can include handles 39 extending rearwardly of chair 32. In one embodiment, user transport chair 30 is a conventional wheelchair. Chair 32 can be formed of material which is easily wiped down and sanitized. For example, chair 32 can be formed of plastic or leather.

Coupling device 40 removably couples user transport chair 30 to cart transport apparatus 50. Coupling device 40 can provide a quick release to quickly detach transport chair 30 from cart transport apparatus 50. Coupling device 40 can include magnets 41a, 41b. Magnet 41a is coupled to transport chair 30. Magnet 41b is coupled to cart transport apparatus 50. Magnets 41a, 41b are aligned to ensure uniform attraction between each other. In one embodiment magnet 41a is embedded in transport chair 30. Magnet 41b is embedded in cart transport apparatus 50. Magnets 41a, 41b can be neodymium magnets. In one embodiment magnets 41a, 41b are formed of N52 grade neuodymium magnets. Magnets 41a, 41b can be coated with a protective coating of a corrosion resistant material. Frame 42 is coupled or integral with user transport chair 30. In one embodiment, frame 42 includes footrest 44 at end 45 of frame 42. Secondary latch 46 can be a secondary coupling member for coupling transport chair 30 to cart transport apparatus 50. For example, secondary latch 46 can be a mechanical latch. Magnetic shield 47a, 47b can be placed behind respective magnets 41a, 41b. Magnetic shield 47a, 47b can be formed of ferrite to ensure that magnets 41a, 41b do not interfere with electronic components of cart transport apparatus 50. Indicator 48 can be associated with magnets 41a, 41b. Indicator 48 can be activated once a secure connection is established between magnets 41a, 41b. Indicator 48 can include visual and audible alerts. For example, indicator 48 can include LED indicators.

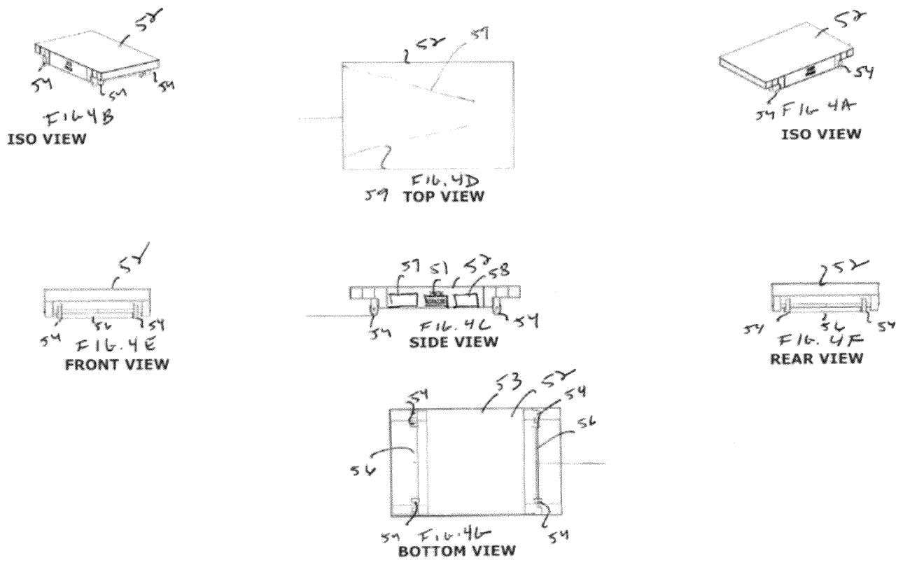

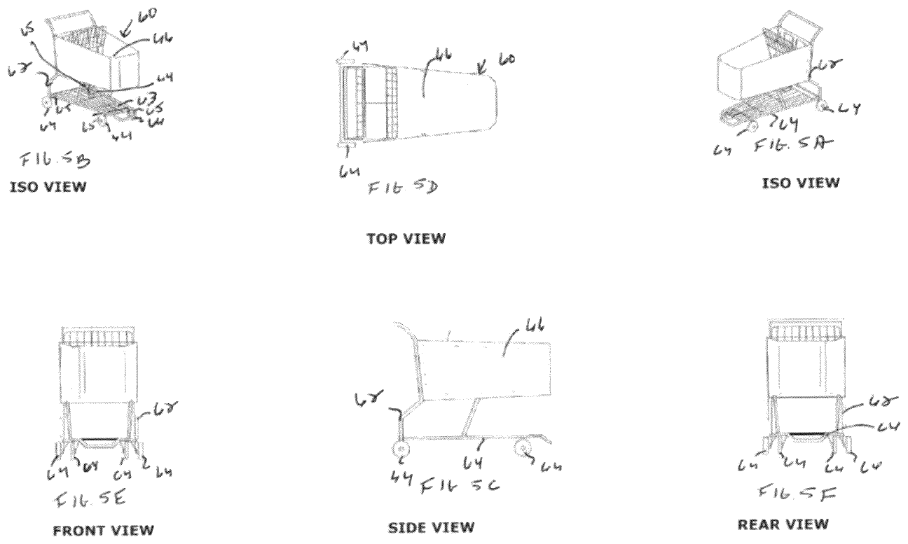

Referring to FIG. 1A, cart transport apparatus 50 includes platform housing 52. Referring to FIGS. 4A-4G, platform housing 52 includes wheels 54 attached to bottom surface 53 of platform housing 52 adjacent each corner 55. In one embodiment, a pair of wheels 54 are attached to axle 56 as shown in FIG. Motor controller 57 and motor 58 can be located inside platform housing 52. Motor 58 can be coupled to wheels 54 and/or axle 57 for controlling rotation and direction of wheels 54. Power source 51 can power motor controller 57 and motor 58. Power source 51 can be a rechargeable battery charged by electricity, for example at an electric charging station.

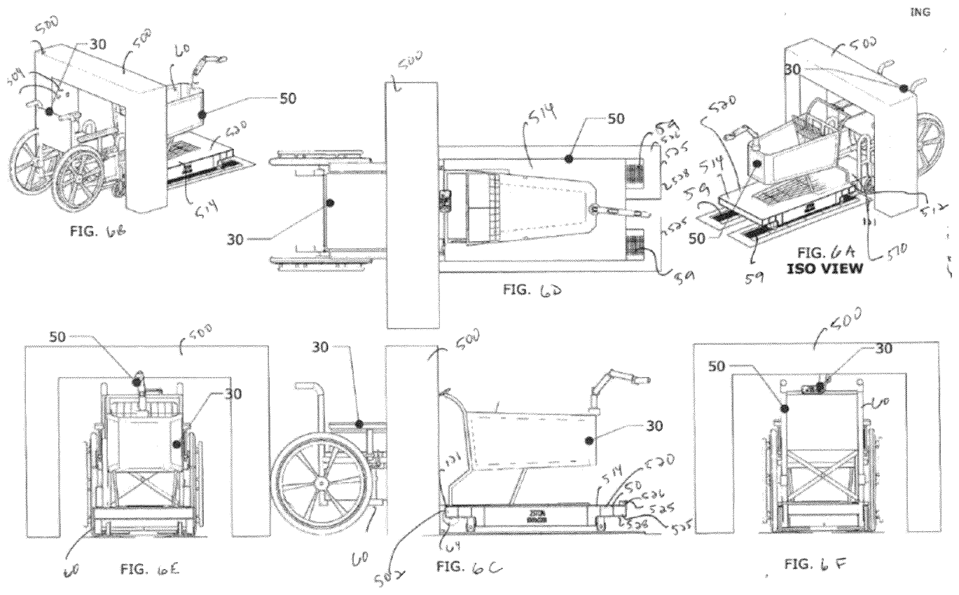

Referring to FIGS. 5A-5F, cart 60 includes frame 62. Frame 62 includes base 63. Wheels 64 can be attached to bottom surface 63 of frame 62 adjacent each corner 65. Cart basket 66 is attached to frame 62. Handles 69 extend rearwardly of cart basket 66. In one embodiment, cart 60 is a conventional shopping cart.

Referring to FIGS. 6A-6F, cart 60 is removably coupled to cart transport apparatus 50. In one embodiment, wheels 64 of cart 60 are received in cart transport apparatus 50. Retractable rails 59 can be used with cart transport apparatus 50. Sanitization system 500 can be used to sanitize autonomous intelligent motorized audible navigation cart 20 after use. Sensors 121 can be used to detect proximity of cart transport apparatus 50 to sanitization system 500. Upon detection of cart transport apparatus 50 to sanitization system 500, retractable rails 59 can extend outwardly to align with sanitization system 500 with cart transport apparatus 50. Once retractable rails 59 engage with sanitization system 500, locking system 502 can lock cart transport apparatus 50 to sanitization system 500 to ensure stability during the sanitization process of sanitization system 500. For example, locking system 502 can be a magnetic or mechanical locking system. Retractable rails 59 can move cart transport apparatus 50 at a consistent speed through sanitization system 500. Sanitization system 500 can include nozzles 504 for applying liquid or gaseous materials for sanitization. For example, sanitization system 500 can be a system as manufactured by PEGGS.

After sanitization, retractable rails 59 can automatically retract to disengage cart transport apparatus 50 and allow cart transport apparatus 50 to be used again. Retractable rails 59 can be powered by power source 51 of cart transport apparatus 50. Retractable rails 59 can be formed of a corrosion resistant material to withstand the sanitization process of sanitization system 500. Safety mechanisms can be included in retractable rails 59 to prevent accidental extension of retractable rails when cart transport apparatus 50 is in motion or during use.

Ramp 510 can be integrated into cart transport apparatus 50. Ramp 510 can be formed of PVI aluminum. Ramp 510 can be used as a footrest for a user of cart transport apparatus 50. Mounting brackets 512 can be used to attach ramp 510 to cart transport apparatus 50. Upper surface 514 of ramp 510 can be formed of a non-slip material. Protection housing 520 can extend around at least a portion of cart transport apparatus 50. Protection housing 520 can be formed of plastic or foam. Bumpers 525 can be used on top 526 and bottom 528 of protection housing 520. Bumbers 525 can be used for shock absorption. Bumpers 525 can be formed of rubber or foam.

User interface 70, is coupled to cart transport apparatus 50. In one embodiment, user interface 70 includes user input device 72. User input device 72 can be a smart phone, such as an Android or iPhone. User input device mount 73 can removably receive user input device 72. Software application 74 running on user input device 72 can be used to receive input and control navigation system 10. In one embodiment, software application 74 is an app. User interface 70 and/or software application 74 can include speech recognition technology. User input device 72 and/or can include facial recognition system 75. Facial recognition system 75 can be used to allow autonomous intelligent motorized audible navigation cart 20 to identify customers and personalize their shopping experience

Robotic arm system 80 can be coupled to cart transport apparatus 50. Robotic arm system 80 can include mount 82 removably mounting robotic arm 84 to cart transport apparatus 50. Clasping device 86 can be positioned at end 85 of robotic arm 84. Camera 87 can be associated with end 85 of robotic arm 84. Robotic arm system 80 can be controlled by user interface 70 and/or artificial intelligence system 100 to grasp and release one or more items and place them within cart basket 66.

User interface 70 can include one or more force feedback sensors 76 which can be grasped by the user as shown in FIG. 1B and FIG. 1C. Force feedback sensors 76 are controlled by artificial intelligence system 100 interacting with robotic arm system 80 to provide resistance, allowing the user to perceive the shape and texture of objects. User interface 70 can include haptic feedback system 77. Haptic feedback system 77 includes one or more vibration devices 78. Vibration devices 78 can be incorporated into backrest 35 and armrest 37 to conveys information to the user through vibrations on one or more of armrests 37 or backrest 35. The vibrations from vibration devices 78 can signal actions of robotic arm system 80. For example, haptic feedback system 77 can signal a position of robotic arm 84 and movement of robotic arm 84, for example extending, retracting, rotating. One or more sensors 79 can be positioned in armrest 37 for sensing positions of a hand or arm of a user contacting armrest 37. Sensing user input device 81 can be associated with user interface 70 for sensing arm or hand positions of a user.

Artificial intelligence system 100 utilizing camera 87 can provide information to user interface 70 regarding items or objects characteristics, such as for example, size, shape and texture. Artificial intelligence system 100 can provide information to user interface 70 regarding confirmations of actions, such as object grasped by clasping device 86 of robotic arm 84 item and object placed in cart basket 66. Artificial intelligence system 100 can analyze visual data from camera 87 and translate the data into tactile representations. In one embodiment, an outline of a detected object is traced on armrest 37 using vibration devices 78 allowing a user to feel what the camera 87 of robotic arm sees. In one example, a deaf-blind user can guide robotic arm 84 to explore the contours of a sculpture, feeling its shape and texture through force feedback sensors 76 and haptic vibrations from vibration devices 78. In one example, clasping device 86 of robotic arm 84 grasps a can such as from a shelf. Haptic feedback system 77 using vibration devices 78 vibrates a pattern on armrest 37, conveying a cylindrical shape and smooth texture of the can. In one example, camera 87 of robotic arm 84 detects a staircase. Haptic vibrations from vibration devices 78 provides a series of distinct vibrations on backrest 35, indicating the direction and incline of the stairs.

Artificial Intelligence system 100 can interpret nuanced gestures and predicts user intent to provide smoother and more intuitive control of robotic arm 84. This benefits both blind and deaf-blind users by increasing precision and control over their environment.

Artificial Intelligence system 100 analyzes subtle variations in hand movements and touch gestures from sensors associated with armrests 37 or sensing user input device 81 to understand the user's intended actions for robotic arm 84 allowing for finer control of position and orientation of robotic arm 84 and grip with clasping device 86.

Artificial Intelligence system 100 learns the user's patterns and preferences over time, predicting the user's next intended action based on current movements and the context of the situation which allows robotic arm 84 to respond more smoothly and naturally to the user's commands.

Haptic feedback can be provided haptic feedback system 77 using vibration devices 78 to confirm interpretation by AI system 100 of the user's gestures and to communicate the actions of robotic arm 84 enhancing the user's sense of control and awareness.

Artificial Intelligence system 100 provides finer control of robotic arm 84, enabling users to manipulate objects with greater accuracy and dexterity. Artificial Intelligence system 100 provides natural and intuitive interaction with robotic arm 84, reducing the cognitive load and enhancing the user experience.

Artificial Intelligence system 100 provides users with greater confidence in their ability to control robotic arm 84 and interact with their environment. Artificial Intelligence system 100 provides makes robotic arm 84 more accessible to users with varying levels of dexterity and motor control. Artificial Intelligence system 100 provides new possibilities for using robotic arm in various tasks, such as retrieving items from shelves, exploring objects, or interacting with touchscreens.

For example, a blind user wants to pick up a delicate object from a shelf. Artificial Intelligence system 100 interprets the user's gentle touch on armrest 37 and instructs robotic arm 84 to grasp the object with a light and precise grip, preventing damage. For example, a deaf-blind user guides robotic arm 84 to explore a museum exhibit. Artificial Intelligence system 100 predicts the user's intended movements and smoothly adjusts position of robotic arm 84, providing a seamless and intuitive tactile experience.

User interface 70 can utilize Bluetooth 5.0 or later to provide high bandwidth, low latency, and extended range, ensuring reliable communication between robotic arm system 80, artificial intelligence system 100 and user input device 72. Bluetooth profiles can be used to provide specific functionalities, such as Advanced Audio Distribution Profile (A2DP) can be included for high-quality audio streaming of voice prompts, environmental descriptions, and alerts, crucial for blind and visually impaired users. Hands-Free Profile HFP can be included to enable hands-free voice control of autonomous intelligent motorized audible navigation cart 20 and robotic arm system 80, allowing users to interact with the chair safely and conveniently.

AVRCP (Audio Video Remote Control Profile) can be included to allow users to control media playback on user input device 72 from user interface 70, enhancing user experience and independence.

Encryption algorithms can be included to protect all data transmitted between the autonomous intelligent motorized audible navigation cart 20 and user input device 72, ensuring confidentiality and preventing unauthorized access. An example, encryption algorithm is AES-256. Secure authentication protocols, such as Secure Simple Pairing (SSP), with passkeys or PIN codes, can be included to verify the identity of paired devices of navigation system 10, preventing unauthorized control of motorized audible navigation cart 20. User data, including personal preferences and navigation history, can be protected both during transmission and storage in navigation system 10, ensuring privacy and security.

Adaptive Frequency Hopping (AFH) can be included to allow navigation system 10 to dynamically select Bluetooth frequencies with the least interference, minimizing disruptions from other devices and ensuring a robust connection in crowded environments. Navigation system 10 prioritizes connection stability for critical functions like navigation and obstacle avoidance, while dynamically adjusting bandwidth for less critical functions like audio streaming, ensuring optimal performance and safety.

Bluetooth seamlessly integrates user input device 72, leveraging its processing power and familiar interface for enhanced accessibility and control. Wireless control eliminates the need for cumbersome cables, providing greater freedom of movement and reducing tripping hazards, particularly important for users with visual impairments. Users can personalize settings and preferences on user input device 72, which are then seamlessly transferred with Bluetooth in navigation system 10, enhancing comfort and user satisfaction. Bluetooth facilitates remote troubleshooting and software updates, ensuring the chair remains functional and up-to-date, minimizing disruptions for the user. A blind user easily pairs user input device 72 with navigation system using a simple voice command or tactile input, and navigation system 10 confirms the connection with an auditory alert. Navigation system 10 maintains a stable Bluetooth connection even in a crowded shopping mall, using adaptive frequency hopping, ensuring uninterrupted navigation and obstacle avoidance. The user adjusts the volume and voice settings of navigation system 10 audio feedback through user input device 72, optimizing the auditory experience to the user's preferences.

Artificial Intelligence system 100 can be trained on dataset 102 of product names and descriptions which are in a particular location. For example, dataset 102 can be accessed over internet 110 from website 103 or one or more databases 104. For example, website 103 can be associated with a store, such as a supermarket. Artificial Intelligence system 100 can customize navigation system 10 to navigate to products of interest to a particular customer using user interface 70 and/or user input device 72. Navigation system 10 can guide autonomous intelligent motorized audible navigation cart 20 through the store, suggesting an optimal path for the customer for shopping based on the customer's list or preferences, utilizing real-time inventory and store layout data. Artificial Intelligence system 100 can provide interactive assistance, such as product information, alternatives, price comparisons, nutritional data, and the like a user's request at user input device 72.

Speech recognition technology at user interface 70, such as an app, translates audible data into to text. Artificial Intelligence system 100 map data to calculate the shortest path to one or more destinations and between destinations within a particular location. Artificial Intelligence system 100 can send navigation instructions to motor controller 57 of autonomous intelligent motorized audible navigation cart 20. Motor controller 57 can move autonomous intelligent motorized audible navigation cart 20 along a path calculated by Artificial Intelligence system 100.

Artificial Intelligence system 100 can generate audible instructions to user interface 70 for navigation of a path to the product and/or motor controller 57 can automatically transport autonomous intelligent motorized audible navigation cart 20 to a location of a desired product. Robotic arm 84 can be used to pick up located products or items at the destination and removably store them in the autonomous intelligent motorized audible navigation cart 20.

Tracking system 120 can track the position of the autonomous intelligent motorized audible navigation cart 20 in real time. Sensors 121 and/or cameras 122 can be associated with autonomous intelligent motorized audible navigation cart 20 to continuously scan the environment for obstacles Sensors 121 can be ultrasonic sensors to detect obstacles in front of the cart. Sensors 121 can be infrared sensor to detect the edges of aisles and other features of the store layout. Cameras 122 can be used to identify products and to track movement of autonomous intelligent motorized audible navigation cart 20 through the store.

Motor controller 57 can stop motor 58 from moving autonomous intelligent motorized audible navigation cart 20 if an obstacle is detected in the way of the autonomous intelligent motorized audible navigation cart 20. Cameras 122 and Artificial Intelligence system can be used to recognize items as they're placed in the cart or fetched with robotic arm 84, automatically updating a digital tally of the items and cost. Robotic arm 84 and Artificial Intelligence system can be used for recognition and retrieval of items from shelves at various heights and depths. This feature is particularly beneficial for customers who might have difficulties reaching certain items due to their height, mobility limitations, or health issues.

User interface 70 and Artificial Intelligence system 100 can be used to provide a highly personalized and adaptive command mapping system that allows users, including blind and visually impaired users, to control functions using a built-in screen reader of input device 72 that describes aloud what appears on screen 71 of input device 72, such as for example VoiceOver gestures from user input device 72. Users can customize mapping of VoiceOver gestures, for example swipes, taps, rotor options, to specific chair functions, such as speed control and navigation of autonomous intelligent motorized audible navigation cart 20 and arm movement of robotic arm system 80. VoiceOver gestures from input device 72 allows for a individualized control scheme tailored to each user's preferences and abilities and allows blind and deaf-blind users to control the chair and access its functionalities using familiar voice commands and gestures they already use input device 72.

Artificial Intelligence system 100 can interpret VoiceOver gestures based on the user's current context, such as navigating, shopping, interacting with robotic arm 84. This ensures commands are executed accurately and efficiently, preventing unintended actions. Artificial Intelligence system 100 learns the user's command patterns and preferences over time, predicting their intentions and adapting the mapping system to provide a more intuitive and responsive experience.

VoiceOver gestures of user input device 72 empowers users to control autonomous intelligent motorized audible navigation cart 20 with the assistive technology they already know, promoting autonomy and self-reliance, eliminates the need to learn new control schemes, making the chair immediately usable and accessible to a wider range of users, provides personalized and context-aware mapping streamlines interactions, allowing users to perform actions quickly and efficiently, accurate and reliable command interpretation builds user confidence, encouraging exploration and mastery of functionalities of autonomous intelligent motorized audible navigation cart 20 and allows diverse user preferences and abilities, making the chair adaptable and user-friendly for individuals with varying levels of VoiceOver proficiency.

In one example, a user maps a two-finger swipe up to increase speed and a two-finger swipe down to decrease speed, aligning with their preferred VoiceOver navigation gestures. In one example, when robotic arm 84 is activated, a “swipe right” gesture is interpreted as “rotate arm right,” while in navigation mode, the same gesture means “turn chair right.” Artificial Intelligence system 100 can use learning for adaptation. For example, Artificial Intelligence system 100 notices that the user frequently uses a three-finger tap to stop the chair, even though the default mapping is a double-tap. Artificial Intelligence system 100 adapts and begins recognizing the three-finger tap as a valid “stop” command.

User interface 70 and Artificial Intelligence system 100 can be used to provide a highly personalized and adaptive command mapping system that allows users, including blind, visually impaired and deaf-blind users, to control functions using VoiceOver gestures from user input device 72.

Blind users can leverage the familiar VoiceOver gestures, such as swipes, taps, rotor option from user input device 72 to control navigation system 10. For example, user input device 72 can be an iPhone. Artificial Intelligence system 100 interprets the gestures in real-time, translating them into specific actions, such as adjusting speed, activating robotic arm 84 or navigating to a destination.

User input device 72 and Artificial Intelligence system 100 can use a built-in screen reader that describes aloud what appears on screen 71, such as for example TalkBack for blind and deaf-Blind Users. For example, user input device 72 can be an Android. Users can utilize TalkBack's gesture controls and auditory feedback to interact with navigation system 10. Artificial Intelligence system 100 seamlessly integrates with TalkBack, allowing users to control navigation system 10 using familiar gestures on user input device 72, such as a device touchscreen of an Android.

Users can customize the mapping of VoiceOver or TalkBack gestures to specific chair functions using Artificial Intelligence system 100 which allows for an individualized control scheme tailored to each user's preferences and abilities. Artificial Intelligence system 100 interprets gestures based on the user's current context, such as navigating, shopping, interacting with robotic arm 84 which ensures commands are executed accurately and efficiently, preventing unintended actions.

Artificial Intelligence system 100 learns the user's command patterns and preferences over time, predicting their intentions and adapting the mapping system to provide a more intuitive and responsive experience. VoiceOver gestures of user input device 72 empowers both blind and deaf-blind users to control autonomous intelligent motorized audible navigation cart 20 with the assistive technology they already know, promoting autonomy and self-reliance and eliminates the need to learn new control schemes, making the chair immediately usable and accessible to a wider range of users. Personalized and context-aware mapping streamlines interactions, allowing users to perform actions quickly and efficiently. Accurate and reliable command interpretation builds user confidence, encouraging exploration and mastery of functionalities of autonomous intelligent motorized audible navigation cart 20 to provide diverse user preferences and abilities, making the chair adaptable and user-friendly for individuals with varying levels of VoiceOver or TalkBack proficiency.

In one example, a blind user navigates a museum using familiar VoiceOver commands like “swipe right to turn right” or “double-tap to stop.” In one example, a deaf-blind user activates robotic arm 84 with a TalkBack gesture on user input device 72 and uses additional gestures to guide robotic arm 84 to retrieve an item from a shelf. A user with limited dexterity adjusts settings of autonomous intelligent motorized audible navigation cart 20, for example speed, seat height, audio volume, using voice commands through VoiceOver or TalkBack, eliminating the need for physical buttons or controls.

Artificial Intelligence system 100 can be used to analyzes a user's shopping list, categorizes items, prioritizes them based on store layout, and suggests alternatives if needed. This feature enhances the shopping experience for blind, visually impaired, and deaf-blind users to provide independent shopping. Artificial Intelligence system 100 interprets the shopping list, recognizing items and categorizing them based on product type, for example produce, dairy, pantry which allows for efficient navigation and grouping of related items.

Artificial Intelligence system 100 can use a layout of a store, either through pre-loaded maps or real-time mapping, to prioritize items based on their location within the store to minimize unnecessary backtracking and optimizes the shopping route. If an item is unavailable or out of stock, the Artificial Intelligence system 100 proactively suggests suitable alternatives based on the user's purchase history, dietary preferences, or similar products available in the store.

Artificial Intelligence system 100 has the advantage of streamlining the shopping process by optimizing the route and grouping related items, saving time and effort for users with visual or auditory impairments. Artificial Intelligence system 100 can personalize shopping to individual preferences and needs by suggesting relevant alternatives and adapting the shopping experience to the user's habits. Artificial Intelligence system 100 empowers users to shop autonomously, making informed decisions without relying on external assistance. Navigations system 10 using Artificial Intelligence system 100 makes the shopping experience more accessible to individuals with visual or cognitive impairments who may find it challenging to navigate complex shopping lists or store layouts and minimizes the mental effort required for shopping by organizing and prioritizing the shopping list, allowing users to focus on their selections.

For example, if a user's list includes milk, eggs, and bread, Artificial Intelligence system 100 recognizes that these items are typically located in different sections of the store and plans a route that efficiently guides the user to each section in a logical order. For example, if the user wants a specific brand of yogurt that is out of stock, Artificial Intelligence system 100 suggests a similar yogurt from a different brand based on the user's past purchases and dietary preferences. For example, Artificial Intelligence system 100 learns that the user frequently buys organic produce. When the user adds apples to their list, Artificial Intelligence system 100 automatically suggests the organic option first. For example, a deaf-blind user inputs their shopping list using a Braille display and Artificial Intelligence system 100 analyzes the list and provides haptic feedback with haptic feedback system 77 using vibration devices 78 which vibrate to confirm the items and their prioritized order.

Artificial Intelligence system 100 can dynamically adapt the interpretation of VoiceOver and TalkBack commands based on the user's current context, such as navigating, using robotic arm 84, checking out at a store which ensures commands are executed accurately and efficiently, improving usability for both blind and deaf-blind users. When the user is navigating, VoiceOver and TalkBack gestures are primarily interpreted by Artificial Intelligence system 100 as movement commands, such as “swipe right” to turn right, “swipe up” to move forward. When the user activates robotic arm 84, the same gestures are reinterpreted to control robotic arm 84 movements and actions such as “swipe right” to rotate the robotic arm right, “double-tap” to grasp an object with clasping device 86 of robotic arm 84.

As the user approaches a checkout counter, Artificial Intelligence system 100 can introduce new commands or reinterpret existing gestures to facilitate the checkout process, such as “swipe up” to signal readiness to pay, “double-tap” to confirm purchase.

Navigation system 10 using Artificial Intelligence system 100 provides feedback such as auditory and/or haptic to confirm the user's commands and actions, ensuring they understand how their gestures are being interpreted in different contexts. Navigation system 100 using Artificial Intelligence system 100 provides benefits for blind and deaf-Blind Users, including: improved usability by contextual command adaptation to simplify the user experience by ensuring commands are relevant and intuitive in different situations; increased efficiency to streamline interactions by dynamically adjusting command interpretations, allowing users to perform actions quickly and effectively; enhanced safety which reduces the risk of unintended actions by ensuring commands are interpreted correctly based on the user's current activity and environment; provides users with confidence and peace of mind knowing that navigation system 10 will respond appropriately to their commands in various situations and accommodates diverse needs of blind and deaf-blind users by providing a flexible and adaptable control system that works seamlessly with their preferred assistive technologies.

For example, a blind user navigates a busy store using VoiceOver commands. When they approach a shelf to retrieve an item, Artificial Intelligence system 100 automatically switches to “robotic arm mode,” allowing the user to control robotic arm 84 with familiar gestures. For example, a deaf-blind user explores a museum using TalkBack gestures on their phone. As they approach an interactive exhibit, Artificial Intelligence system 100 reinterprets their gestures to control the exhibit's features, providing a seamless and engaging experience. For example, a blind user approaches the checkout counter, Artificial Intelligence system 100 recognizes the context and prompts the user with a new voice command (“Ready to pay?”) to initiate the checkout process.

Artificial Intelligence system 100 can act as an intelligent shopping companion, providing proactive suggestions and assistance to blind, visually impaired, and deaf-blind users.

Artificial Intelligence system 100 can analyze the user's shopping list and provides timely reminders about items they may have missed or overlooked, ensuring a complete and efficient shopping trip. Artificial Intelligence system 100 can identify relevant offers and promotions based on the user's shopping list and purchase history for saving money and discovering new products. If an item is out of stock, Artificial Intelligence system 100 can suggest suitable alternatives based on the user's preferences, dietary needs, or similar products available in the store.

Artificial Intelligence system 100 can communicate suggestions and reminders through clear auditory cues for blind users and haptic feedback for deaf-blind users, ensuring accessibility for all. Artificial Intelligence system 100 can provide an enhanced shopping experience and creates a more enjoyable and less stressful shopping experience by providing helpful reminders, relevant offers, and alternative suggestions. Artificial Intelligence system 100 can help users stay organized and focused, minimizing the time and effort spent searching for items or making decisions and empowers users to make informed purchasing decisions by providing relevant information and suggesting alternatives. Artificial Intelligence system 100 can provide alerts to users to potential savings and helps them discover new products that align with their preferences. Artificial Intelligence system 100 learns individual needs and preferences, creating a customized shopping experience for each user.

For example, as the user passes the dairy aisle, Artificial Intelligence system 100 reminds them, “Don't forget the milk on your list.” For example, Artificial Intelligence system 100 detects a sale on the user's preferred brand of coffee and notifies them: “There's a special offer on your brand of coffee today. Would you like to add it to your cart?”. For example, if the user wants a specific type of bread that is out of stock, Artificial Intelligence system 100 suggests a similar bread with comparable ingredients and nutritional value. Artificial Intelligence system 100 can interact with haptic feedback system 77 using vibration devices 78 such that a deaf-blind user receives a haptic vibration on armrest 37, signaling a reminder about an item on their list.

Artificial Intelligence system 100 can control robotic arm 84 using Artificial Intelligence and object recognition to enable blind and visually impaired users to independently locate, retrieve, and place items in cart 60. Artificial Intelligence system 100 analyzes a shopping list of a user and store layout data to efficiently navigate to relevant aisles and shelves. Using sensors 121 and/or cameras 122 of tracking system 120, robotic arm 84 identifies specific items, avoids obstacles, and safely grasps and retrieves the desired products. Artificial Intelligence system 100 then guides robotic arm 84 to accurately place the items in cart 60, minimizing the risk of damage or spills.

Navigation system 10 including Artificial Intelligence system 100 empowers users to shop autonomously, eliminating the need for assistance and promoting self-reliance and streamlines the shopping process by quickly locating and retrieving items, saving time and effort. Navigation system 10 including Artificial Intelligence system 100 provides reduced risk of falls or injuries associated with reaching or searching for items on shelves, creates a more enjoyable and less stressful shopping experience for users with visual impairments and provides a sense of confidence and control in navigating the retail environment and making independent purchasing decisions.

For example, a user requests a specific cereal. Artificial Intelligence system 100 guides autonomous intelligent motorized audible navigation cart 20 to the cereal aisle, and robotic arm 84 scans the shelves, identifying and retrieving the correct box. While reaching for a bottle of juice, robotic arm 84 detects a nearby customer and Artificial Intelligence system 100 pauses intelligent motorized audible navigation cart 20 to avoid collision, ensuring both safety and courtesy. Artificial Intelligence system 100 guides robotic arm 84 to gently place a carton of eggs into the cart, preventing breakage and ensuring other items are not disturbed. If a user requests a plurality of cans, Artificial Intelligence system 100 efficiently locates and retrieves each of the cans, placing them securely in cart 60.

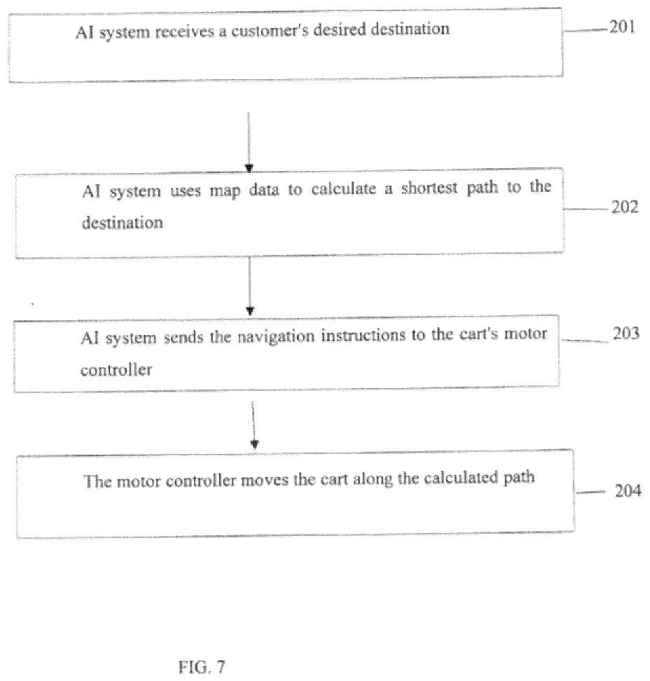

FIG. 7 is a flow diagram of an implementation of a method for navigation of autonomous intelligent motorized audible navigation cart 20. In block 201, Artificial Intelligence system 100 receives customer's desired destination from user interface. In block 202, Artificial Intelligence system 100 uses map data to calculate the shortest path to the destination. In block 203, Artificial Intelligence system 100 sends the navigation instructions to motor controller 57. In block 204, Motor controller 57 moves autonomous intelligent motorized audible navigation cart 20 along the calculated path.

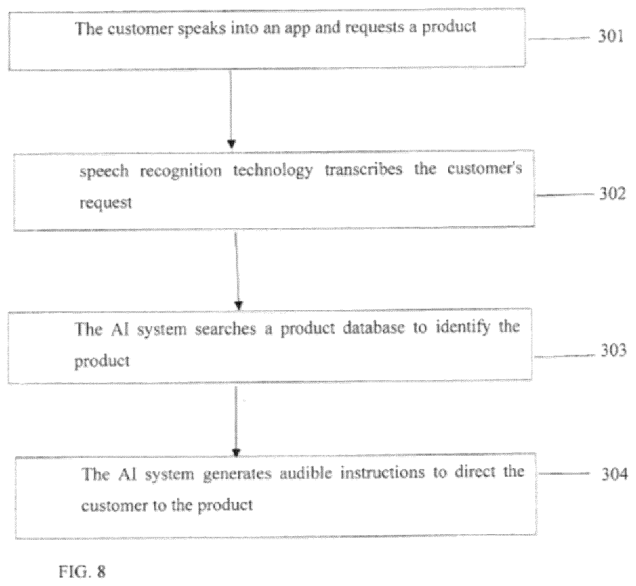

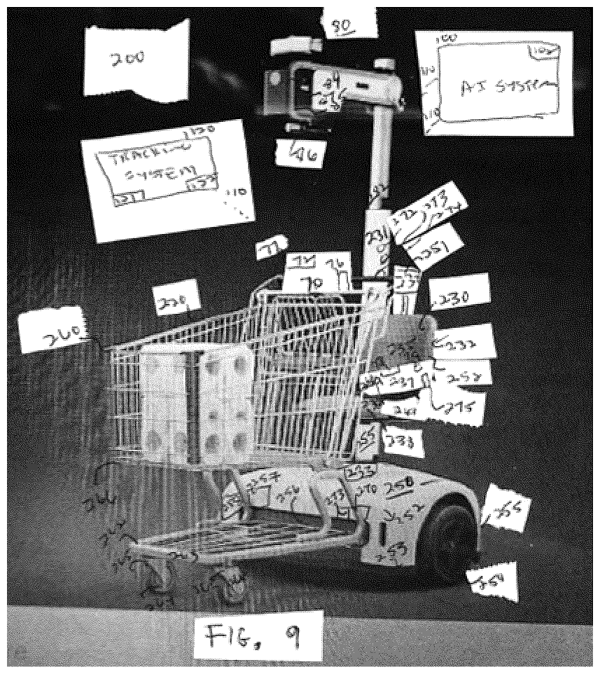

FIG. 8 is a flow diagram of an implementation of a method for audible navigation of autonomous intelligent motorized audible navigation cart 20. In block 301, a customer speaks into user interface such as the app and requests a product. In block 302, speech recognition technology transcribes the customer's request. In block 303, Artificial Intelligence system 100 uses the product database to identify the product. In block 304, Artificial Intelligence system 100 generates audible instructions that transport the customer to the product.

FIG. 9 is a schematic diagram of navigation system 200 in accordance with the teaching of the present invention. Navigation system 200 includes autonomous intelligent motorized audible navigation cart 220. Autonomous intelligent motorized audible navigation cart 220 includes user transport chair 230. User transport chair 230 is removably coupled to shopping cart transport apparatus 250. Alternatively, user transport chair 230 is integral with shopping cart transport apparatus 250.

User transport chair 230 includes frame 231 attaching chair 232 to cart transportation apparatus 250 and robotic arm system 80. Chair 232 can be formed of material which is easily wiped down and sanitized. For example, chair 232 can be made of plastic or leather. Chair 232 can include footrest 233. Chair 232 can include seat 238 with one or two armrests 237 and backrest 235. Alternatively, chair 232 cannot include armrests 237. Chair 232 can include headrest 239. One or more weight sensors 249 can be positioned within or adjacent seat 238 or armrest 237 to sense a weight and weight distribution of a user. One or more depth sensors 251 can be positioned with or adjacent head rest 239 to estimate a height of a user sitting on seat 238. One or more proximity sensors 252 can be associated with chair 232 to detect a user's approach and general position relative to chair 232. Chair adjustment device 255 can receive input form weight sensors 249, depth sensors 251 and proximity sensors 252 and Artificial Intelligence system 100.

Cart transport apparatus 250 includes housing 252. Housing 252 includes wheels 254 extending from bottom surface 253 of platform housing 252 adjacent each corner 255. In one embodiment, a pair of wheels 254 are attached to axle 256. Motor controller 257 and motor 258 can be located inside platform housing 252. Motor 258 can be coupled to wheels 254 and/or axle 257 for controlling rotation and direction of wheels 254. Power source 251 can power motor controller 257 and motor 258. Power source 251 can be a rechargeable battery charged by electricity, for example at an electric charging station.

Cart 260 includes frame 262. Frame 262 includes base 263. Wheels 264 can be attached to bottom surface 263 of frame 262 adjacent each corner 265. Cart basket 266 is attached to frame 262. Handles 269 extend rearwardly of cart basket 266. Cart 260 can be detachable from cart transport apparatus 250 with detachment device 270 to allow user transport chair 230 to be used independently in various environments beyond retail settings, such as museums, libraries, or parks. The detachment mechanism is designed for quick and effortless operation, with clear tactile or auditory cues to confirm successful detachment and reattachment.

Artificial Intelligence system 100 can interface with detachment device 270 for detachment of cart 260, prioritizing user safety and ease of transition between environments. Before detaching, Artificial Intelligence system 100 performs environmental checks using proximity sensors 252 to ensure sufficient clearance and avoid collisions. Artificial Intelligence system 100 can confirm user stability, ensuring they are securely seated and balanced before initiating detachment. The detachment process is initiated through a simple voice command or tactile input to input device 72, and Artificial Intelligence system 100 provides feedback such as auditory or haptic to confirm successful detachment. Artificial Intelligence system 100 can prevent accidental detachment in unsafe situations or when the user is not properly positioned. The simple and intuitive detachment process, with clear feedback, makes it easy for blind and deaf-blind users to transition between environments independently. For example, a blind user approaches a museum entrance. Artificial Intelligence system 100 detects the change in environment and prompts the user to detach cart 260. After confirming user stability and clearance, Artificial Intelligence system 100 safely detaches cart 260, allowing the user to proceed into the museum.

Detachment device 270 can include a lever, a large button, or a touch-sensitive surface to ensure the mechanism is accessible to users with limited dexterity or strength. Detachment device 270 can include physical guides (e.g., tapered edges, alignment pins) to assist with proper alignment of user transport chair 230 and cart 260 during reconnection.

Detachment device 270 can include a secure locking system, such as latches or magnets, that automatically engages when user transport chair 230 and cart 260 are correctly connected. Detachment device 270 can include detachment sensors 273 to verify secure locking and provide feedback, such as an auditory “click” or a tactile vibration.

Artificial Intelligence system 100 can perform the following steps before detachment: environmental scan to use detachment sensors 273 to confirm sufficient clearance around user transport chair 230; user stability check to verify the user is seated securely and not leaning or reaching; and cart alignment: if necessary to guide the user to adjust position of user transport chair 230 for optimal connection to cart 260.

Artificial Intelligence system 100 can provide audio prompts to guide the user through the reconnection process, for example “Align the chair with the cart,” “Connection successful”). Artificial Intelligence system 100 can provide feedback mechanisms for deaf-blind users using haptic vibrations and tactile indicators with haptic feedback system 77. Artificial Intelligence system 100 can provide audio commands, such as “Detach cart” or a designated tactile gesture with haptic feedback system 77 to initiate detachment. Artificial Intelligence system 100 can provide an auditory confirmation, such as “Cart detached” a distinct haptic vibration with haptic feedback system 77 to confirm successful detachment.

User transport chair 230 or frame 231 can include WiFi positioning sensors 272, RFID readers 273 and navigation sensors 274. When detached from cart 260, user transport chair 230 utilizes WiFi positioning sensors 272, RFID readers 273 and navigation sensors 274 to provide precise and reliable navigation within indoor environments, such as museums and libraries.

WiFi positioning sensors 272 of user transport chair 230 chair can sense WiFi infrastructure within a building to triangulate position of user transport chair 230. By analyzing signal strength from WiFi positioning sensors 272 from multiple access points, Artificial Intelligence system 100 can determine location of user transport chair 230 with accuracy.

RFID readers 273 of user transport chair 230 can detect RFID tags within an environment. RFID tags can provide location specific information, such as “You are approaching the Impressionist Gallery” or “Turn left for the restroom.”

Navigation sensors 274 can be for example LiDAR, ultrasonic and inertial to provide real-time obstacle detection and environmental mapping to ensure safe navigation around people, furniture, and other obstacles. User transport chair 230 can include joystick 275 for control of positioning of user transport chair 230 and interfacing robotic arm 84.

Artificial Intelligence system 100 can dynamically adjust a speed and trajectory of user transport chair 230, providing clear auditory cues and haptic feedback to guide the user safely and efficiently through the indoor space. For example, a blind user navigates a museum using audio cues from RFID tags, receiving directions like “Turn right at the next RFID tag to enter the Egyptian exhibit”. For example, a deaf-blind individual locates a specific book section in a library, guided by haptic feedback and RFID tag announcements. For example, a user finds their way to a specific store within a shopping mall, aided by WiFi positioning and real-time obstacle avoidance capabilities of user transport chair 230.

User interface 70 is coupled to cart transport apparatus 250. Robotic arm system 80 can be coupled to cart transport apparatus 250. Robotic arm system 80 can include mount 282 removably mounting robotic arm 84 to frame 231 of cart transport apparatus 250. Clasping device 86 can be positioned at end 85 of robotic arm 84. Camera 87 can be associated with end 85 of robotic arm 84. Robotic arm system 80 can be controlled by user interface 70 and/or artificial intelligence system 100 to grasp and release one or more items and place them within cart basket 266.

Artificial Intelligence system 100 can process data from weight sensors 249, depth sensors 251 and proximity sensors 252 in real-time to create a dynamic user profile such as height and weight of a user. Based on this profile, chair adjustment device 255 can automatically adjust seat height of chair 252, such as to lower for easier entry and raise to a comfortable level for use. Chair adjustment device 255 can automatically adjust height of armrests 237 to ensure proper arm support and ergonomics. Chair adjustment device 255 can change the angle of chair 252 to allow chair 252 to tilt or recline to accommodate users of different heights and weights. Chair adjustment device can adjust position of leg rest 233 to extend or retract to provide optimal legroom.

Artificial Intelligence system 100 can learn and store individual user preferences positioning of chair 232 over time to create a customized experience, automatically adjusting chair 232 to a user's preferred settings upon approach to chair 232.

Artificial Intelligence system 100 and chair adjustment device 255 can proactively adjust chair 232 based on real-time sensor data, enhancing user experience and accessibility. By considering both height and weight, the Artificial Intelligence system 100 creates a more complete user profile, enabling finer adjustments for optimal comfort and ergonomics to ensure a comfortable and supportive seating position for users of all sizes and body types. Artificial Intelligence system 100 and chair adjustment device 255 can make chair 232 easier to use for individuals with limited mobility or flexibility who may have difficulty making manual adjustments. Artificial Intelligence system 100 and chair adjustment device 255 can reduce the risk of discomfort or injury caused by improper seating posture or chair positioning. Artificial Intelligence system 100 and chair adjustment device 255 can eliminate the need for users to manually adjust chair 232, streamlining the entry and exit process.

For example, a tall user approaches chair 232. Depth sensors 231 detect height of the user and chair adjustment device 255 automatically raises seat 238 and armrests 237 to accommodate longer limbs of the user. For example, a user with a heavier build sits in chair 232. Weight sensors 249 detect weight distribution of the user and chair adjustment device 255 adjusts an angle of seat 238 and a position of footrest 233 to provide optimal support and balance. For example, a user with limited mobility approaches chair 232 in a wheelchair. Proximity sensors 232 sense presence of the user and chair adjustment device 255 automatically lowers chair 232 to facilitate a smooth and effortless transfer.

User transport chair 220 and Artificial Intelligence system 100 can incorporate tactile sign language recognition and/or a haptic feedback system 77 using vibration devices 78 to ensure accessibility for deaf-blind users. Sensors on the armrests 237 or a wearable device interpret the user's hand movements, translating them into commands for user transport chair 232 and robotic arm 84. User transport chair 230 communicates information to the user through distinct vibration patterns on the armrests, seat, or backrest using haptic feedback system 77. These vibrations convey directional cues, object detection alerts, and confirmations of actions for deaf-blind individuals who rely on tactile communication and environmental awareness for interaction and navigation.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

I claim:

1. A navigation system comprising:
an autonomous intelligent motorized audible navigation cart, the autonomous intelligent motorized audible navigation cart configured to be removably coupled to a user transport chair and a shopping cart;
a user interface coupled or associated with the autonomous intelligent motorized audible navigation cart, the user interface controlling the autonomous intelligent motorized audible navigation cart;
a robotic arm system removably coupled to the autonomous intelligent motorized audible navigation cart, robotic arm system comprising a clasping device and a camera positioned at an end of a robotic arm;
a tracking system comprising one or more sensors and/or cameras to track a position of the autonomous intelligent motorized audible navigation cart; and
an artificial intelligence system associated with or part of the user interface, wherein the artificial intelligence system receiving information from the user interface, the camera of the robotic arm system and the one or more sensors and/or cameras of the tracking system for controlling movement of the autonomous intelligent motorized audible navigation cart and operation of the robotic arm system.

2. The navigation system according to claim 1, wherein the autonomous intelligent motorized audible navigation cart includes a cart transport apparatus and further comprising a coupling device for coupling the user transport chair to the cart transport apparatus, the coupling device being a quick release device.

3. The navigation system according to claim 2, wherein the coupling device comprises a first magnet coupled to the user transport chair and a second magnet coupled the cart transport apparatus.

4. The navigation system according to claim 2 wherein the cart transport apparatus comprises a platform housing including a plurality of wheels attached to a bottom surface of platform housing or each of an axle, a motor controller and a motor positioned inside the platform housing, the motor is coupled to the wheels and/or axle for controlling rotation and direction of the wheels and a power source to power the motor controller and the motor 58.

5. The navigation system according to claim 2 wherein the shopping cart includes a plurality of wheels, at least one of the wheels being received in a retractable rail of the cart transport apparatus.

6. The navigation system according to claim 1 wherein the user interface comprises a user input device.

7. The navigation system according to claim 6 wherein the user input device is a smartphone including speech recognition and/or facial recognition.

8. The navigation system according to claim 1 wherein the user interface includes one or more force feedback sensors.

9. The navigation system according to claim 1 wherein the user interface includes a haptic feedback system, the haptic feedback system comprising one or more vibrations devices positioned in an armrest or backrest of the user transport chair to convey information to the user interface through vibrations of the one or more vibration devices to signal actions of the robotic arm system including a position of the robotic arm and the movement of the robotic arm and one or more sensors positioned in the armrest for sensing positions of a hand or arm of a user contacting the armrest.

10. The navigation system according to claim 9 wherein the artificial intelligence system utilizing the camera provides information to the user interface regarding characteristics of items or objects and provides information to the user interface of confirmations of actions of the clasping device and the artificial intelligence system translates the information into tactile representations in which an outline of a detected object is traced on the armrest using the vibration devices or provides a series of distinct vibrations of the vibration devices indicating a direction and incline of stairs.

11. The navigation system according to claim 9 wherein the artificial intelligence system includes tactile sign language recognition to interpret information from the one or more sensors on the armrest or a wearable device and translates the information into commands for controlling the user transport chair and the robotic arm system and communicates information to the user through distinct vibration patterns of the one or more vibrations devices on the armrest, a seat, or the backrest.

12. The navigation system according to claim 1 wherein the user device includes one or more sensors in the armrest or a sensing user input device, the artificial intelligence system analyzes information in the more sensors in the armrest or a sensing user input device to control the robotic arm system.

13. The navigation system according to claim 1 wherein the user interface includes a screen reader of an input device to provide gestures from the user input device and the artificial intelligence system maps the gestures to functions of the autonomous intelligent motorized audible navigation cart or movements of the robotic arm system.

14. The navigation system according to claim 1 wherein the user transport chair includes one or more weight sensors positioned within or adjacent a seat or an armrest of the user transport chair to sense a weight and weight distribution of a user, one or more depth sensors positioned within or adjacent a head rest of the user transport chair to estimate a height of a user sitting on a seat of the user transport chair, one or more proximity sensors associated with the user transport chair to detect approach of a user and a position of the user relative to the user transport chair and a chair adjustment device configured to receive input from the one or more weight sensors, the one or more depth sensors and the one or more proximity sensors and information from the artificial system for automatically changing a position of the seat.

15. The navigation system according to claim 1 wherein the autonomous intelligent motorized audible navigation cart includes a cart transport apparatus and further a frame attaching the user transport chair to the cart transport apparatus.

16. The navigation system according to claim 15 wherein the robotic arm system is attached to an end of the frame.

17. The navigation system according to claim 15 wherein the user transport chair and/or the frame includes one or more WiFi positioning sensors, one or more RFID readers and one or more navigation sensors, wherein the one or more WiFi positioning sensors are configured to sense WiFi infrastructure within an environment or building to triangulate position of the user transport chair, the one or more RFID reader detect RFID tags within the environment or building and the one or more navigation sensors provide real-time obstacle detection and environmental mapping to ensure safe navigation in the environment or building.

18. The navigation system according to claim 1 wherein the artificial intelligence system includes tractile sign language recognition to interpret commands and to translate into commands for controlling the autonomous intelligent motorized audible navigation cart and the robotic arm system and further comprising a detachment device for engaging autonomous intelligent motorized audible navigation cart and shopping cart, the detachment device including sensors for verifying engagement of the autonomous intelligent motorized audible navigation cart with the shopping cart.

19. A method for navigating comprising the steps of:
a navigation system receiving a desired destination from a user interface of an autonomous intelligent motorized audible navigation cart;
calculating a shortest path to a desired destination with an artificial intelligence system using map data;
determining navigation instructions by the artificial intelligence system based on the shortest path; and
controlling movement of the autonomous intelligent motorized audible navigation cart along the determined navigation instructions.

20. A method for navigating comprising the steps of:
a navigation system receiving audible information of a product from a user interface of an autonomous intelligent motorized audible navigation cart; receiving information at a user interface of a product;
transcribing the audible information with speech recognition into request data;
determining a location of the request data by an artificial intelligence system using a product database to identify the product; and
controlling movement of the autonomous intelligent motorized audible navigation cart to the determined location or providing audible navigation instructions to the determined location.
